(19) United States
(12) Patent Application Publication
(10) Pub. No.: US 2017/0055036 A1
(43) Pub. Date: Feb. 23, 2017

(54) REMOTE CONTROL METHOD, CONTROLLED DEVICE, AND REMOTE CONTROLLER

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventors: Jun GUO, Tianjin (CN); Xingran WANG, Tianjin (CN)

(21) Appl. No.: 15/219,686

(22) Filed: Jul. 26, 2016

Related U.S. Application Data
(63) Continuation of application No. PCT/CN2016/086585, filed on Jun. 21, 2016.

(30) Foreign Application Priority Data
Aug. 17, 2015 (CN) 201510505689.8

(51) Int. Cl. H04N 21/475; G06F 3/0489; H04N 21/485; G06F 3/0484; H04N 21/462; G06F 17/30; G06F 3/0482

(52) U.S. Cl. CPC H04N 21/4755; G06F 17/30876; G06F 3/0489; G06F 3/0482; G06F 3/04847; G06F 3/04845; H04N 21/4622; H04N 21/4858; G05B 2219/13164

(57) ABSTRACT

The disclosure provides a remote control method, a controlled device, and a remote controller, and the method includes: receiving a button value transmitted by a remote controller; if the received button value is a pre-stored button value of a customized key, then displaying a shortcut operation interface including a pre-configured set of shortcut entrance identifiers of at least one service resource; receiving a selection instruction transmitted by the remote controller for a shortcut entrance identifier in the set of shortcut entrance identifiers; and opening a service resource corresponding to the selected shortcut entrance identifier. With the technical solution according to the disclosure, a user can access a desired resource via the shortcut operation interface to thereby simplify the operations by the user of selecting the resource to be accessed so as to improve the experience of the user.

### CROSS REFERENCE TO RELATED APPLICATIONS

This application is a continuation of International Application No. PCT/CN2016/086585, filed on Jun. 21, 2016, which is based upon and claims priority to Chinese Patent Application No. 201510505689.8, filed on Aug. 17, 2015, the entire contents of which are incorporated herein by reference.

### TECHNICAL FIELD

The present disclosure relates to the field of remote control technologies, and particularly to a remote control method, a controlled device, and a remote controller.

### BACKGROUND

As the technologies are being developed constantly, a controlled device providing a user with a TV program function (e.g., an intelligent TV set, a TV box, etc.,) can provide the user with both a live TV program, and a function to access a network resource, e.g., to access video contents, audio contents, a picture, etc., available from a multimedia resource server.

At present, the user typically accesses a resource (including a live TV program and a network resource) by selecting in a TV menu through a remote controller. For example, a resource provider categorizes the resources into a multi-level TV menu, so that the user accessing a resource firstly enters the first level of TV menu through the remote controller, where the first level of menu includes general categories of the resources, for example, the general categories include signal sources, videos, applications, functions of the controlled device, etc.; and then the user enters the second level of menu from the first level of menu through the remote controller, and finally enters the last level of menu through the remote controller, and then selects the resource to be accessed.

As there are a growing variety of live TV programs and network resources, there are an increasing number of service resources so that there are an increasing number of levels in the multi-level TV menu, or service resources at each level of menu, thus making it more and more complex to select the resource to be accessed.

### SUMMARY

The disclosure provide a remote control method, a controlled device, and a remote controller so as to address the problem in the prior art of increasing complexity of accessing a resource to be accessed.

In one aspect, an embodiment of the disclosure provides a remote control method applicable to a controlled device, the method including:

receiving a button value transmitted by a remote controller;

if the received button value is a pre-stored button value of a customized key, then displaying a shortcut operation interface including a pre-configured set of shortcut entrance identifiers of at least one service resource;

receiving a selection instruction transmitted by the remote controller for a shortcut entrance identifier in the set of shortcut entrance identifiers; and

opening a service resource corresponding to the selected shortcut entrance identifier.

In another aspect, an embodiment of the disclosure provides a remote control method applicable to a remote controller, the method including:

detecting an operation performed on a customized button on the remote controller;

if the detected operation is a preset operation, then transmitting a button value of the customized button to a controlled device so that the controlled device displays a shortcut operation interface including a preconfigured set of shortcut entrance identifiers of at least one service resource; and

transmitting a selection instruction for a shortcut entrance identifier in the set of shortcut entrance identifiers to the controlled device so that the controlled device opens the service resource corresponding to the selected shortcut entrance identifier.

In another aspect, an embodiment of the disclosure provides a controlled device including:

at least one processor; and

a memory communicably connected with the at least one processor for storing instructions executable by the at least one processor, wherein execution of the instructions by the at least one processor causes the at least one processor to:

receive a button value transmitted by a remote controller;

if the received button value is a pre-stored button value of a customized key, then display a shortcut operation interface comprising a pre-configured set of shortcut entrance identifiers of at least one service resource;

receive a selection instruction transmitted by the remote controller for a shortcut entrance identifier in the set of shortcut entrance identifiers; and

open a service resource corresponding to the selected shortcut entrance identifier.

In another aspect, an embodiment of the disclosure provides a remote controller including:

at least one processor; and

a memory communicably connected with the at least one processor for storing instructions executable by the at least one processor, wherein execution of the instructions by the at least one processor causes the at least one processor to:

detect an operation performed on a customized button on the remote controller;

if the detected operation is a preset operation, then transmit a button value of the customized button to a controlled device so that the controlled device displays a shortcut operation interface comprising a preconfigured set of shortcut entrance identifiers of at least one service resource; and

transmit a selection instruction for a shortcut entrance identifier in the set of shortcut entrance identifiers to the controlled device so that the controlled device opens a service resource corresponding to the selected shortcut entrance identifier.

With the remote control methods according to the embodiments of the disclosure, if the received button value is the button value of the customized button, then the shortcut operation interface will be displayed which includes a pre-configured set of shortcut entrance identifiers of at least one service resource, so that a user can access the shortcut operation interface using the customized button to thereby access the desired service resource, via the shortcut operation interface. For example, the user can set as needed a shortcut entrance identifier of a service resource of interest in the shortcut operation interface, so that the user can enter the shortcut operation interface using the customized button, and search for and access the resource of interest rapidly in the shortcut operation interface. The operation steps of selecting the resource to be accessed can be saved, the operations by the user can be simplified, and the experience of the user can be improved, as compared with the prior art in which the user has to search for and access the resource among a large number of service resources of no interest to the user in a multi-level TV menu through the remote controller.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flow chart of a remote control method applicable to a controlled device according to an embodiment of the disclosure;

FIG. 2 is a schematic diagram of renaming a signal source according to an embodiment of the disclosure;

FIG. 3 is an exemplary flow chart of a remote control method applicable to a remote controller according to an embodiment of the disclosure;

FIG. 4 is an exemplary flow chart of a remote control method according to an embodiment of the disclosure;

FIG. 5 is a schematic diagram of a shortcut operation interface according to an embodiment of the disclosure;

FIG. 6 is a schematic diagram of an operation interface of a management function according to an embodiment of the disclosure;

FIG. 7 is a first schematic diagram of an addition interface according to an embodiment of the disclosure;

FIG. 8 is a second schematic diagram of an addition interface according to an embodiment of the disclosure;

FIG. 9 is a third schematic diagram of an addition interface according to an embodiment of the disclosure;

FIG. 10 is a fourth schematic diagram of an addition interface according to an embodiment of the disclosure;

FIG. 11 is a schematic diagram of a shortcut operation interface after a shortcut entrance identifier is added according to an embodiment of the disclosure;

FIG. 12 is a schematic structural diagram of a controlled device according to an embodiment of the disclosure;

FIG. 13 is a schematic structural diagram of a remote controller according to an embodiment of the disclosure;

FIG. 14 is a schematic structural diagram of a controlled device according to an embodiment of the disclosure; and

FIG. 15 is a schematic structural diagram of a remote controller according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

As introduced in the Background of the Disclosure, there are a growing variety of service resources, for example, the service resources can include videos, e.g., children programs, cartoons, movies, teleplays, variety shows, sporting, etc.; the service resources can also include setting of a controlled device, e.g., adjusting up or down of the volume, altering the display brightness, the hue balance, etc., of the controlled device, etc.; and the service resources can further include applications in the controlled device, e.g., a weather forecast, a calendar, etc. There are an increasing number of categories of service resources so that there are an increasing number of levels in the multi-level TV menu, or categories at each level of menu. The inventors have identified during their development that although there are a growing variety of resources, there are a limited number of resources of interest to a particular user, that is, there is a demand of each user for only a small number of resources, for example, generally a child is concerned with only children programs, a basketball fan is concerned with only basketball programs, etc. In view of this, the technical solutions according to the embodiments of the disclosure provide the user with a personalized service so that the user can locate his or her favorite resource more rapidly and conveniently.

Particularly a remote control method according to an embodiment of the disclosure will be described below in details in connection with particular embodiments thereof.

### First Embodiment

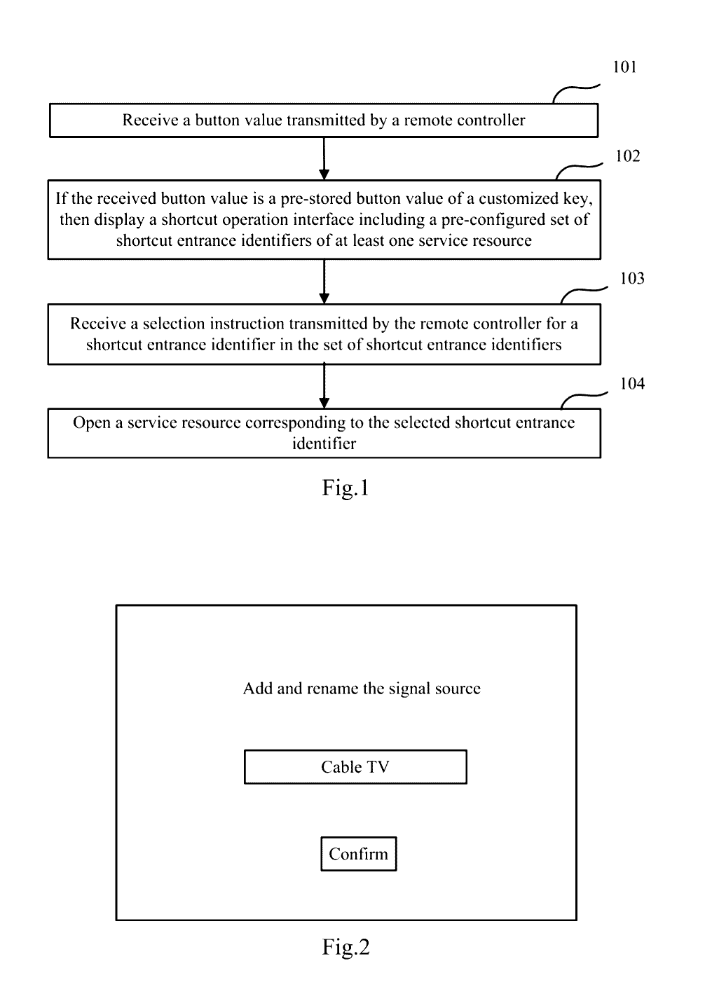

As illustrated in FIG. 1, there is an exemplary flow chart of a remote control method according to an embodiment of the disclosure, the method being applicable to a controlled device, where the method includes the following operations:

The operation 101 is to receive a button value transmitted by a remote controller;

The operation 102 is, if the received button value is a pre-stored button value of a customized key, to display a shortcut operation interface including a pre-configured set of shortcut entrance identifiers of at least one service resource;

The operation 103 is to receive a selection instruction transmitted by the remote controller for a shortcut entrance identifier in the set of shortcut entrance identifiers; and

The operation 104 is to open a service resource corresponding to the selected shortcut entrance identifier.

Here in the operation 104, if the service resource is an application, then an operation interface of the application will be displayed; if the service resource is a particular teleplay, e.g., “Journey to the West”, then a page of episodes of the teleplay will be displayed; and if the service resource is a function setting page of the controlled device to set the display brightness, network setting, etc., of the controlled device, for example

Here in an embodiment, in order for a user to manage the shortcut operation interface, the set of shortcut entrance identifiers includes a shortcut entrance identifier of a management function to manage the shortcut operation interface; and if the selected shortcut entrance identifier is the shortcut entrance identifier of the management function, then the service resource opened in the operation 104 will be an operation interface of the management function, so that the user can enter the operation interface of the management function via the shortcut operation interface to thereby management the set of shortcut entrance identifiers in the shortcut operation interface.

Here in an embodiment, after the operation interface of the management function is opened, the method further includes the following operations:

The operation A1 is to receive a control instruction for the set of shortcut entrance identifiers, where the control instruction includes any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter the position where a shortcut entrance identifier in the set of shortcut entrance identifiers is displayed in the shortcut operation interface; and

The operation A2 is to perform a corresponding operation in response to the control instruction.

Here in an embodiment, management on the shortcut operation interface will described below in details.

Here in an embodiment, a database can be preset in which display information required for displaying the operation interface of the management function is stored (referred to as a shortcut function database), and the operation interface of the management function can be opened particularly by retrieving the display information for the operation interface of the management function from the preset shortcut function database, and displaying the operation interface of the management function according to the display information.

1) In order to add a shortcut entrance identifier to the shortcut operation interface, the operation interface of the management function includes an entrance to an addition interface to add a shortcut entrance identifier to the set of shortcut entrance identifiers; and the controlled device can receive the addition instruction transmitted by the user via the addition interface, and perform the corresponding operation particularly as follows:

If the operation interface of the management function includes an addition option to add a shortcut entrance identifier to the set of shortcut entrance identifiers, then if the control instruction is an addition instruction, then the control instruction for the set of shortcut entrance identifiers can be received in the operation A1 particularly in the following operations:

The operation B1 is to receive a selection instruction transmitted by the remote controller for an entrance to the addition interface, and to retrieve from the shortcut function database and display at least one of category identifier of the service resource in response to the selection instruction;

The operation B2 is to receive a selection instruction transmitted by the remote controller for the category identifier, and to retrieve from the shortcut function database and display a shortcut entrance identifier of at least one service resource corresponding to the selected category identifier in response to the selection instruction;

Here in an embodiment, the selected category identifier can be highlighted so that the user can know which service resource is selected;

Of course, the selected shortcut entrance identifier can also be highlighted for the same reason;

The operation B3 is to receive a selection instruction transmitted by the remote controller for the shortcut entrance identifier, and to determine the selection instruction as the addition instruction; and

The operation B4 is to add the selected shortcut entrance identifier to the set of shortcut entrance identifiers in response to the addition instruction.

Here in an embodiment, the controlled device can maintain a shortcut interface database which can include the shortcut entrance identifiers in the shortcut operation interface, and resource identifiers corresponding to the shortcut entrance identifiers.

Here in an embodiment, a shortcut entrance identifier which can be added can be a shortcut entrance identifier of a service resource in the first level of menu, or the second level of menu, the third level of menu, and so on until a shortcut entrance identifier of a service resource in the last level of menu.

For example, a shortcut entrance identifier which can be added can be any one or combination of the following service resources:

Signal sources, videos, a play record, applications, setting of the controlled device, etc., where the videos can further include channels and a play record, and the channels can be categories of network resources, e.g., teleplays, movies, cartoons, variety shows, etc.; the applications include system applications pre-loaded in the control device (e.g., file management, a calendar, weather, etc.), and third-party applications installed by the user on the controlled device; and for example, setting of the controlled device is a one-click health check on the controlled device, disabling a display screen, putting the controlled device into hibernation, adjusting up or down the volume of the controlled device, adjusting the brightness or the hue balance of the controlled device, etc.

Here in an embodiment, if a shortcut entrance identifier of a play record is added to the set of shortcut entrance identifiers, then the user can locate the shortcut entrance identifier of the play record in the shortcut operation interface, and open the play record by selecting the shortcut entrance identifier to view his or her own play record.

Here in an embodiment, a shortcut entrance identifier in the shortcut operation interface can be a video name (e.g., the Romance of the Three Kingdoms). At this time, if the user selects the video name, then the operation 104 can be performed by continuing with playing video contents corresponding to the video name and starting with a point of time when the video contents were lastly stopped from being played. For example, if the video name of the Romance of the Three Kingdoms is present in the shortcut operation interface, if the user watches the Romance of the Three Kingdoms up to a point of time which is 10 minutes and 10 seconds in the 10th episode, then the controlled device will play the Romance of the Three Kingdoms starting with 10 minutes and 10 seconds in the 10th episode of the Romance of the Three Kingdoms after the user selects the Romance of the Three Kingdoms on the shortcut operation page, unlike the prior art in which the user searches for the Romance of the Three Kingdoms among a large number of service resources in the multi-level TV menu, and selects the 10th episode thereof. With the technical solution according to the embodiment of the disclosure, the user can continue with watching the Romance of the Three Kingdoms starting with the point of time when it was lastly stopped from being watched, via the shortcut operation interface to thereby simplify the operations by the user and improve the experience of the user.

Here in an embodiment, the number of shortcut entrance identifiers in the shortcut operation interface is a preset number, that is, only a preset number of shortcut entrance identifiers can be added to the shortcut operation interface. If the number of shortcut entrance identifiers in the shortcut operation interface reaches the preset number, then an indicator that the shortcut operation interface is full of shortcut entrance identifiers, after the operation B1 or the operation B2, and before the operation B3 is performed, so that the user can know that the number of shortcut entrance identifiers in the shortcut operation interface has reached the preset number, and no further shortcut entrance identifier can be added thereto.

2) Here in an embodiment, a shortcut entrance identifier can include a resource name and/or a resource icon.

If the shortcut entrance identifier includes the resource name, then a selected signal source can be renamed to thereby be identified by the user, particularly in the following operations:

The operation C1 is to receive a rename instruction to rename the signal source, where the rename instruction includes a name of the renamed signal source; and

The operation C2 is to add the name of the renamed signal source to the shortcut entrance identifier of the signal source.

Here in an embodiment, the operation C1 and the operation C2 can be performed after the operation B2 and before the operation B3, for example, if they are performed after the operation B2, then the controlled device will display the interface as illustrated in FIG. 2 so that the user rename the selected signal source in the interface, and then the operation C1 and the operation C2 will be further performed. Of course, the operation C1 and the operation C2 can alternatively be performed on an occasion as preset by the user, and the embodiment of the disclosure will not be limited thereto. For example, the operation interface of the management function can provide an entrance to a rename interface to rename a shortcut entrance identifier so that the user accessing the entrance and entering the rename interface can rename a resource name in the respective shortcut entrance identifier.

Here in an embodiment, if a shortcut entrance identifier of a signal source is added to the set of shortcut entrance identifiers, then the shortcut interface database can further include a name of the renamed signal source stored corresponding to the shortcut entrance identifier of the signal source.

Of course, it shall be noted that the shortcut interface database can store only the shortcut entrance identifiers, and if other information of a service resource corresponding to one of the shortcut entrance identifiers needs to be retrieved, then the information can be retrieved from the shortcut function database using the shortcut entrance identifier.

3) The service resources of interest to the user can be further categorized into primary and secondary service resources. Thus in an embodiment of the disclosure, the user can set as needed the positions where the respective shortcut entrance identifier are displayed in the shortcut operation interface so that the user searches as usual for a shortcut entrance identifier corresponding to a service resource. In an embodiment of the disclosure, the operation interface of the management function includes an entrance to a movement interface to alter the position where at least one of the shortcut entrance identifiers in the set of shortcut entrance identifiers is displayed in the shortcut operation interface. In view of this, the controlled device receives a movement instruction transmitted by the user via the movement interface, and changes the position where the shortcut entrance identifier is displayed in the shortcut operation interface, in response to the movement instruction, particularly in the following operations:

The operation D1 is to display the movement interface upon reception of a selection instruction transmitted by the remote controller for the entrance to the movement interface;

The operation D2 is to receive a selection instruction transmitted by the remote controller for a shortcut entrance identifier in the movement interface;

Here in an embodiment, the selected shortcut entrance identifier can be highlighted;

The operation D3 is to receive a movement instruction transmitted by the remote controller to move the selected shortcut entrance identifier. In a particular implementation, for example, if the user selects the shortcut entrance identifier using a selection button on the remote controller, then the user can move the selected shortcut entrance identifier using Up, Down, Left, and Right switching buttons preset on the remote controller, Fore example, if the user presses the Left switching button, then the selected shortcut entrance identifier will be moved leftward, and if the user presses the Right switching button, then the selected shortcut entrance identifier will be moved rightward. The shortcut entrance identifier is moved each time at a step which can be determined as needed in reality, and the embodiment of the disclosure will not be limited thereto.

The operation D4 is to move the position where the selected shortcut entrance identifier is displayed, in response to the movement instruction.

For example, if the shortcut entrance identifiers in the short operation interface are sorted from the top to the bottom and from the left to the right, then the lastly sorted shortcut entrance identifier can be moved to the firstly sorted position and displayed there in response to the operation by the user.

Here in an embodiment, the shortcut interface database records the positions where the respective shortcut entrance identifiers in the set of shortcut entrance identifiers are displayed in the shortcut operation interface. If the position where at least one of the shortcut entrance identifiers is displayed in the shortcut operation interface is altered, then the positions where the respective shortcut entrance identifiers are displayed will be updated in the shortcut interface database in response to a result of the alteration operation so that the respective shortcut entrance identifiers are displayed at the updated positions in the shortcut operation interface.

4) In order for the user to delete a shortcut entrance identifier in the shortcut operation interface, the operation interface of the management function includes an entrance to a deletion interface to delete at least one of the shortcut entrance identifiers in the set of shortcut entrance identifiers. In view of this, the controlled device can receive a deletion instruction as follows, and delete the shortcut entrance identifier in the shortcut operation interface in response to the deletion instruction, particularly in the following operations:

The operation E1 is to receive display the deletion interface upon reception of a selection instruction transmitted by the remote controller for the entrance to the deletion interface;

The operation E2 is to receive a selection instruction transmitted by the remote controller for a shortcut entrance identifier in the deletion interface;

Here in an embodiment, the selected shortcut entrance identifier can be highlighted;

Here for the sake of a convenient operation by the user, at least one shortcut entrance identifier can be selected;

The operation E3 is to receive a deletion instruction transmitted by the remote controller to delete the selected shortcut entrance identifier; and

The operation E4 is to delete the selected shortcut entrance identifier from the set of shortcut entrance identifiers in response to the deletion instruction.

Here in an embodiment, if the position where at least one shortcut entrance identifier is displayed in the shortcut operation interface is deleted, then the positions where the remaining shortcut entrance identifiers are displayed will be updated in the shortcut interface database in response to a result of the deletion operation so that the respective shortcut entrance identifiers are displayed at the updated positions in the shortcut operation interface.

In summary, in the embodiments of the disclosure, if the received button value is the button value of the customized button, then the shortcut operation interface will be displayed which includes a pre-configured set of shortcut entrance identifiers of at least one service resource, so that the user can access the shortcut operation interface using the customized button to thereby access the service resource to be accessed, via the shortcut operation interface. For example, the user can set as needed a shortcut entrance identifier of a service resource of interest in the shortcut operation interface, so that the user can enter the shortcut operation interface using the customized button, and search for and access the resource of interest rapidly in the shortcut operation interface. The operation steps of selecting the resource to be accessed can be saved, the operations by the user can be simplified, and the experience of the user can be improved, as compared with the prior art in which the user has to search for and access the resource among a large number of service resources of no interest to the user in a multi-level TV menu through the remote controller.

Moreover the user can access the management function in the shortcut operation interface using the shortcut entrance identifier of the management function to thereby customize the shortcut operation interface, for example, by adding, deleting, and moving a shortcut entrance identifier in the shortcut operation interface, or renaming a resource of a signal source, so that the user can customize the shortcut operation interface in a personalized manner as needed to thereby improve the experience of the user, and the adherence thereof to the product.

### Second Embodiment

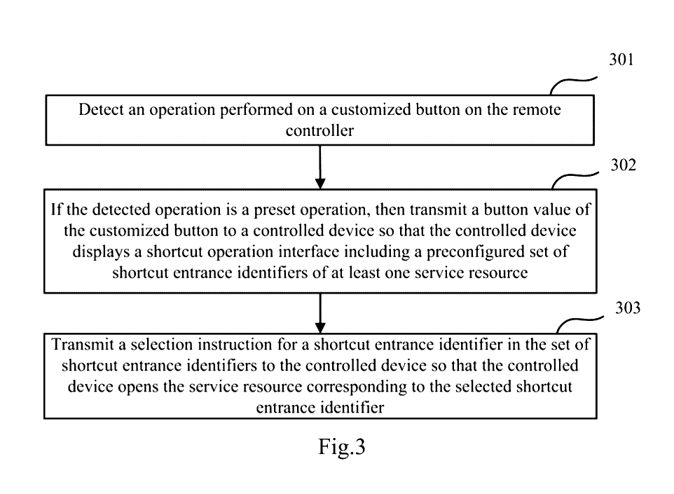

As illustrated in FIG. 3, there is an exemplary flow chart of a remote control method according to an embodiment of the disclosure, the method being applicable to a remote controller, where the method includes the following operations:

The operation 301 is to detect an operation performed on a customized button on the remote controller;

Here in an embodiment, the customized button can be embodied in the following three implementations:

In a first implementation, the customized button can be a button arranged on the remote controller to call out a shortcut operation interface, where the number of buttons on the remote controller is increased due to the customized button. Particularly, if the user performs a preset operation on the customized button, then the remote controller will transmit a button value of the customized button to a controlled device, and the controlled device will receive a display instruction transmitted by the remote controller to display the shortcut operation interface, upon reception of the button value of the customized button;

In a second implementation, in order to avoid the number of buttons on the remote controller from being increased, alternatively a preset operation can be performed on an existing button on the remote controller to thereby trigger the remote controller to transmit an instruction to display the shortcut operation interface. For example, the preset operation can be double clicking or long pressing. Particularly two button values corresponding to one button can be triggered, for example, if a single-click operation is performed, then the first button value will be triggered so that the user performs a normal operation of the button; and if the double-click operation is performed (i.e., the preset operation), then the second button value will be triggered, where the second button value is a button value to transmit the display instruction;

In a third implementation, in order to avoid the number of buttons on the remote controller from being increased, alternatively a combined button value of existing buttons on the remote controller, which are arranged in a preset order can be determined as a button value of the customized button. For example, channel selection button 8 (with a corresponding button value of 8), 9 (with a corresponding button value of 9), 1 (with a corresponding button value of 1), and 0 (with a corresponding button value of 10) on the remote controller are combined in sequence, thus resulting in a button value of 8910, which is the button value of the customized button;

The operation 302 is, if the detected operation is a preset operation, to transmit a button value of the customized button to a controlled device so that the controlled device displays a shortcut operation interface including a preconfigured set of shortcut entrance identifiers of at least one service resource; and

The operation 303 is to transmit a selection instruction for a shortcut entrance identifier in the set of shortcut entrance identifiers to the controlled device so that the controlled device opens the service resource corresponding to the selected shortcut entrance identifier.

Here in an embodiment, in order for a user to manage the shortcut operation interface, the set of shortcut entrance identifiers includes a shortcut entrance identifier of a management function to manage the shortcut operation interface.

Here in an embodiment, if the user selects the shortcut entrance identifier of the management function, then in order for the user to manage the shortcut operation interface, in the embodiment of the disclosure, a control instruction for the set of shortcut entrance identifiers can be transmitted to the controlled device so that the controlled device performs a corresponding operation in response to the control instruction, where the control instruction includes any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter the position where a shortcut entrance identifier in the set of shortcut entrance identifiers is displayed in the shortcut operation interface.

Particularly for the sake of convenient understanding, management on the shortcut operation interface will be described below in details.

1) In order to add a shortcut entrance identifier to the shortcut operation interface, the operation interface of the management function includes an entrance to an addition interface to add a shortcut entrance identifier to the set of shortcut entrance identifiers; and the remote controller can transmit an addition instruction to the controlled device in the following operations;

The operation F1 is to transmit a selection instruction for an entrance to the addition interface to the controlled device so that the controlled device retrieves from a shortcut function database and display at least one category identifier of the service resource in response to the selection instruction;

The operation F2 is to transmit a selection instruction for the category identifier to the controlled device so that the controlled device retrieves from the shortcut function database and display a shortcut entrance identifier of at least one service resource corresponding to the selected category identifier in response to the selection instruction; and

The operation F3 is to transmit a selection instruction for the shortcut entrance identifier to the controlled device so that the controlled device determines the selection instruction as the addition instruction, and adds the selected shortcut entrance identifier to the set of shortcut entrance identifiers.

Here the operation of adding the shortcut entrance identifier to the shortcut operation interface has been described in the first embodiment, so a repeated description thereof will be omitted here.

2) Here in an embodiment, a shortcut entrance identifier can include a resource name and/or a resource icon.

Here in an embodiment, if the selected resource identifier is a resource identifier of a signal source, and the shortcut entrance identifier includes a resource name, then a rename instruction to rename the signal source can be further transmitted to the controlled device to thereby identify the signal source, where the rename instruction includes the name of the renamed signal source so that the controlled device adds the name of the renamed signal source to the shortcut entrance identifier of the signal source.

3) The service resources of interest to the user can be further categorized into primary and secondary service resources. Thus in order for the user to set as needed the positions where the respective shortcut entrance identifiers in the set of shortcut entrance identifiers are displayed in the shortcut operation interface so that the user can search as usual for a shortcut entrance identifier corresponding to a service resource, in an embodiment of the disclosure, the operation interface of the management function includes an entrance to a movement interface to alter the position where at least one of the shortcut entrance identifiers in the set of shortcut entrance identifiers is displayed in the shortcut operation interface. At this time, the remote controller transmit a movement instruction to the controlled device in the following operations:

The operation G1 is to transmit a selection instruction for the entrance to the movement interface to the controlled device so that the controlled device displays the movement interface;

The operation G2 is to transmit a selection instruction for a shortcut entrance identifier in the movement interface to the controlled device; and

The operation G3 is to transmit a movement instruction to move the selected shortcut entrance identifier to the controlled device so that the controlled device moves the position where the selected shortcut entrance identifier is displayed, in response to the movement instruction.

Here the operation of moving the shortcut entrance identifier in the shortcut operation interface has been described in the first embodiment, so a repeated description thereof will be omitted here.

4) In order for the user to delete a shortcut entrance identifier in the shortcut operation interface, the operation interface of the management function includes an entrance to a deletion interface to delete at least one of the shortcut entrance identifiers in the set of shortcut entrance identifiers; and at this time, the remote controller can transmit a deletion instruction to the controlled device in the following operations:

The operation H1 is to transmit a selection instruction for the entrance of the deletion interface to the controlled device so that the controlled device displays the deletion interface;

The operation H2 is to transmit a selection instruction for a shortcut entrance identifier in the deletion interface to the controlled device; and

The operation H3 is to transmit a deletion instruction to delete the selected shortcut entrance identifier to the controlled device so that the controlled device deletes the selected shortcut entrance identifier from the set of shortcut entrance identifiers.

Here the operation of deleting the shortcut entrance identifier has been described in the first embodiment, so a repeated description thereof will be omitted here.

In summary, in the embodiments of the disclosure, the user can call out the shortcut operation interface using the customized button, and locate the shortcut entrance to the resource to be accessed, via the shortcut operation interface, so that the operation operations of selecting the resource to be accessed can be saved, the operations by the user can be simplified, and the experience of the user can be improved, as compared with the prior art in which the user has to search for and access the resource among a large number of service resources of no interest to the user in a number of levels of TV menus through the remote controller.

### Third Embodiment

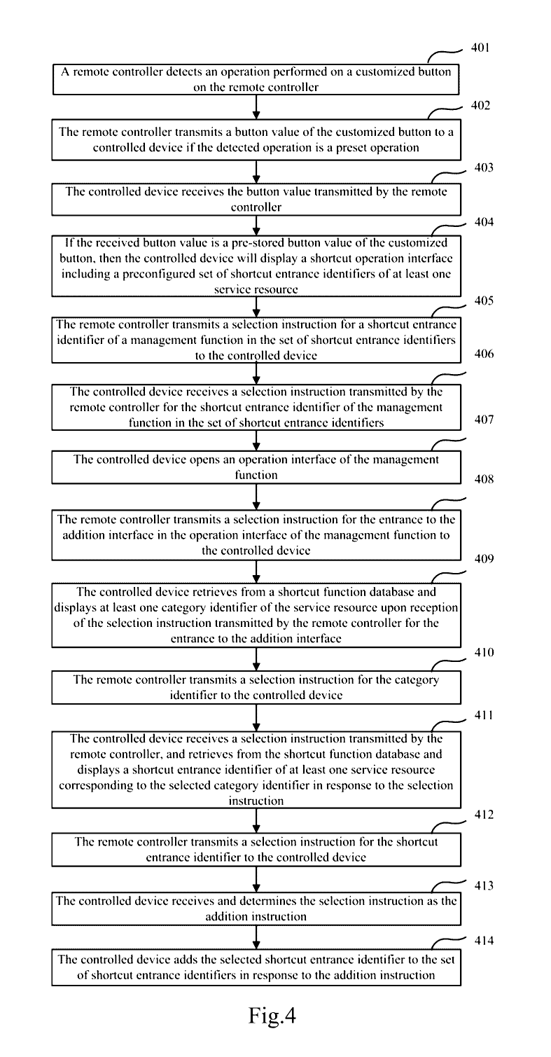

A remote control method according to an embodiment of the disclosure will be described below in details by way of an example in which a shortcut entrance identifier is added to a shortcut operation interface, as illustrated in FIG. 4, where the method includes the following operations:

In the operation 401, a remote controller detects an operation performed on a customized button on the remote controller;

In the operation 402, the remote controller transmits a button value of the customized button to a controlled device if the detected operation is a preset operation;

In the operation 403, the controlled device receives the button value transmitted by the remote controller;

In the operation 404, if the received button value is a pre-stored button value of the customized button, then the controlled device will display a shortcut operation interface including a preconfigured set of shortcut entrance identifiers of at least one service resource;

Here the shortcut entrance identifier displayed in the operation 404 is as illustrated in FIG. 5;

In the operation 405, the remote controller transmits a selection instruction for a shortcut entrance identifier of a management function in the set of shortcut entrance identifiers to the controlled device;

In the operation 406, the controlled device receives a selection instruction transmitted by the remote controller for the shortcut entrance identifier of the management function in the set of shortcut entrance identifiers;

In the operation 407, the controlled device opens an operation interface of the management function;

Where the shortcut operation interface after the shortcut entrance identifier of the management function is selected in the operation 405 is as illustrated in FIG. 5. FIG. 5 highlights the shortcut entrance identifier of the management function by boxing the shortcut entrance identifier of the management function so that the user can know that the current operation object is the management function.

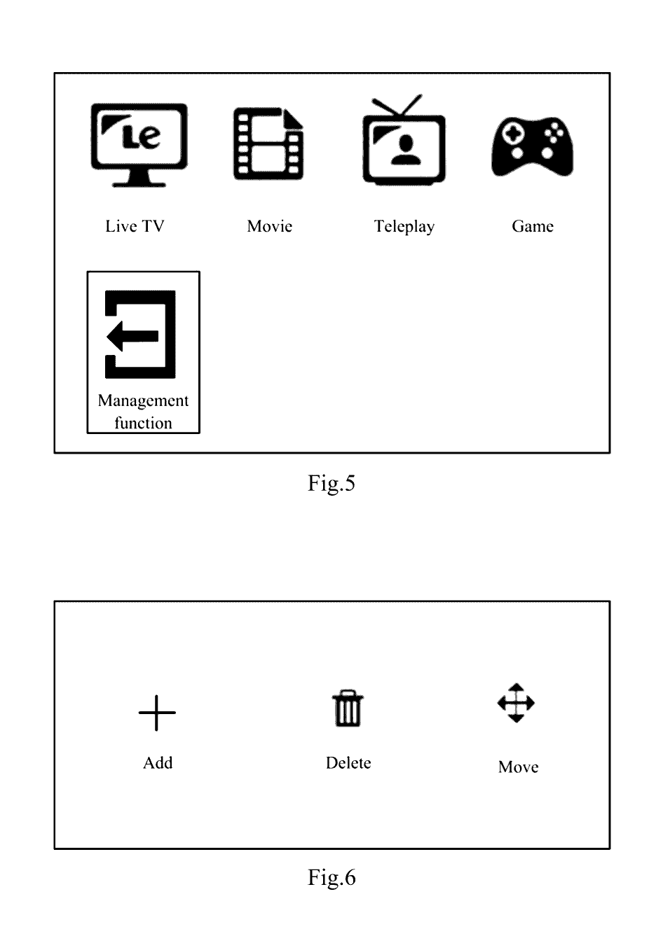

Here FIG. 6 illustrates a schematic diagram of the operation interface of the management function opened in the operation 407, and in FIG. 6, “Add” and the icon above it represent an interface addition entrance, “Delete” and the icon above it represent an interface deletion entrance, and “Move” and the icon above it represent an interface movement interface;

In the operation 408, the remote controller transmits a selection instruction for the entrance to the addition interface in the operation interface of the management function to the controlled device;

In the operation 409, the controlled device retrieves from a shortcut function database and displays at least one category identifier of the service resource upon reception of the selection instruction transmitted by the remote controller for the entrance to the addition interface;

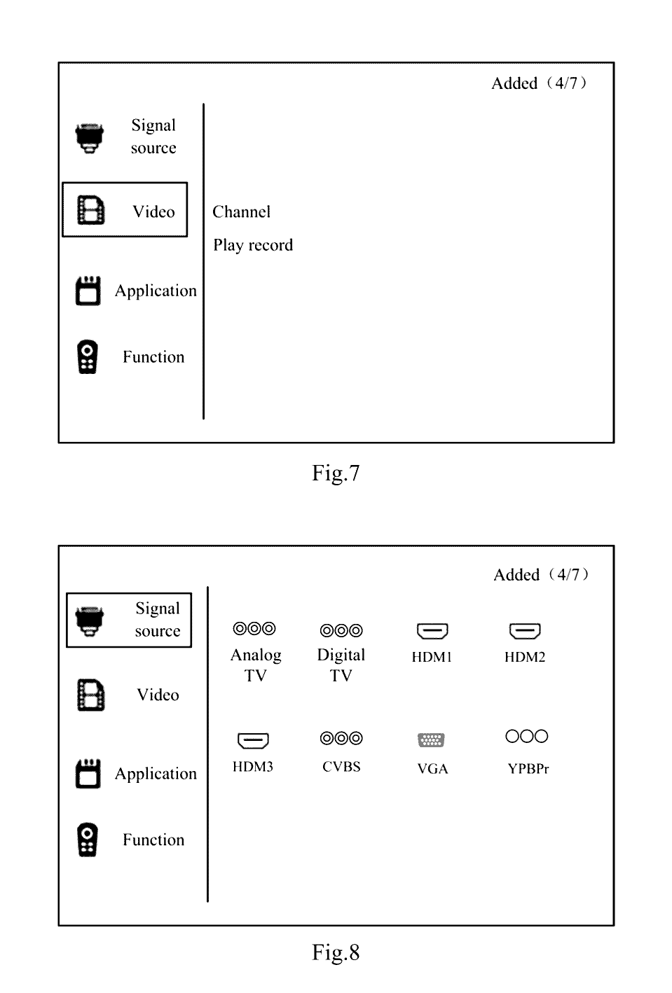

Here FIG. 7 illustrates a schematic diagram of the addition interface, and in FIG. 7, “Added (4/7)” at the top right corner indicates to the user that at most 7 shortcut entrance identifiers can be added to the shortcut operation interface, 4 shortcut entrance identifiers have been added, and 7−4=3 more can be added;

In the operation 410, the remote controller transmits a selection instruction for the category identifier to the controlled device;

Here as illustrated in FIG. 8, the user can select a service to be added in the addition interface illustrated in FIG. 7 in the up-down direction using Up and Down selection buttons.

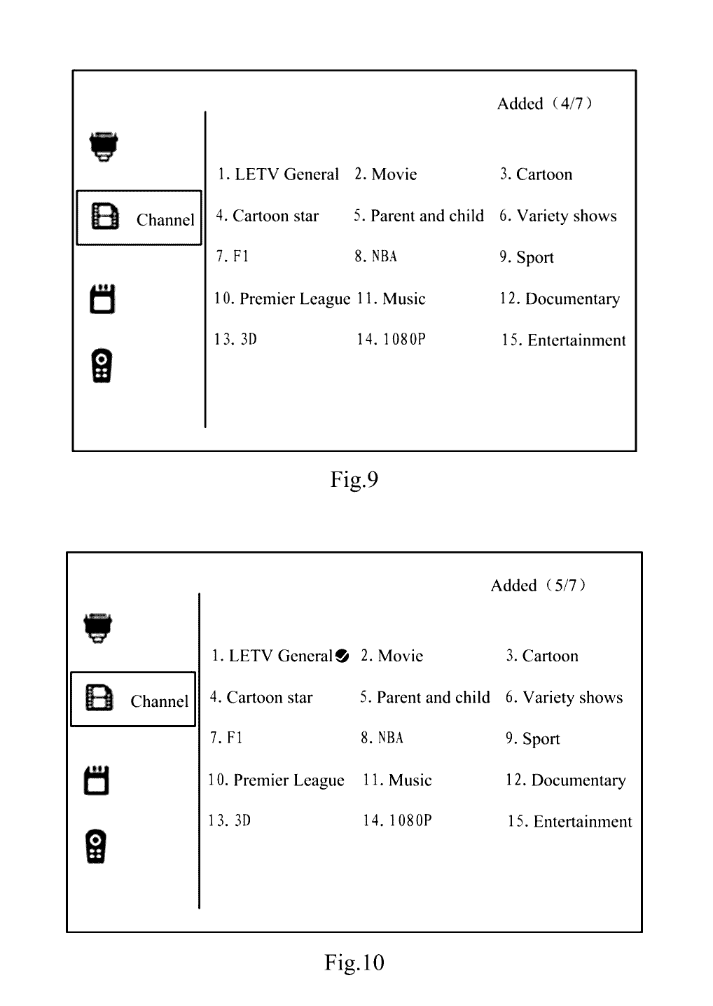

Here for example, if the user selects one of the service resources under a channel in the schematic diagram illustrated in FIG. 7 to be selected, then the service resources under the channel can be displayed, and FIG. 9 illustrates a schematic diagram of the service resources under the channel;

In the operation 411, the controlled device receives a selection instruction transmitted by the remote controller, and retrieves from the shortcut function database and displays a shortcut entrance identifier of at least one service resource corresponding to the selected category identifier in response to the selection instruction;

In the operation 412, the remote controller transmits a selection instruction for the shortcut entrance identifier to the controlled device;

In the operation 413, the controlled device receives and determines the selection instruction as the addition instruction; and

In the operation 414, the controlled device adds the selected shortcut entrance identifier to the set of shortcut entrance identifiers in response to the addition instruction.

As illustrated in FIG. 10, for example, if the user selects the LETV General in the schematic diagram illustrated in FIG. 9 to be added to the shortcut operation interface, then after the controlled device performs the operation 414, “Added (4/7)” at the top right corner in FIG. 9 is changed to “Added (5/7)” illustrated in FIG. 10 to indicate successful addition, and the symbol of “√” is displayed following the LETV General to indicate that the LETV General is selected. Finally FIG. 11 illustrates a schematic diagram of the shortcut operation interface after the operation 414 is performed.

In the embodiments of the disclosure, the user can call out the shortcut operation interface using the customized button, and locate rapidly the shortcut entrance identifier of the resource to be accessed, in the shortcut operation interface to thereby access the resource rapidly. The operations by the user of selecting the resource to be accessed can be simplified to thereby improve the experience of the user. Moreover in the embodiments of the disclosure, the user can customize the shortcut operation interface as preferred so that the user can add the shortcut entrance identifier of his or her favorite resource to the shortcut operation interface, and thus can access the resource of interest later in the shortcut operation interface.

### Fourth Embodiment

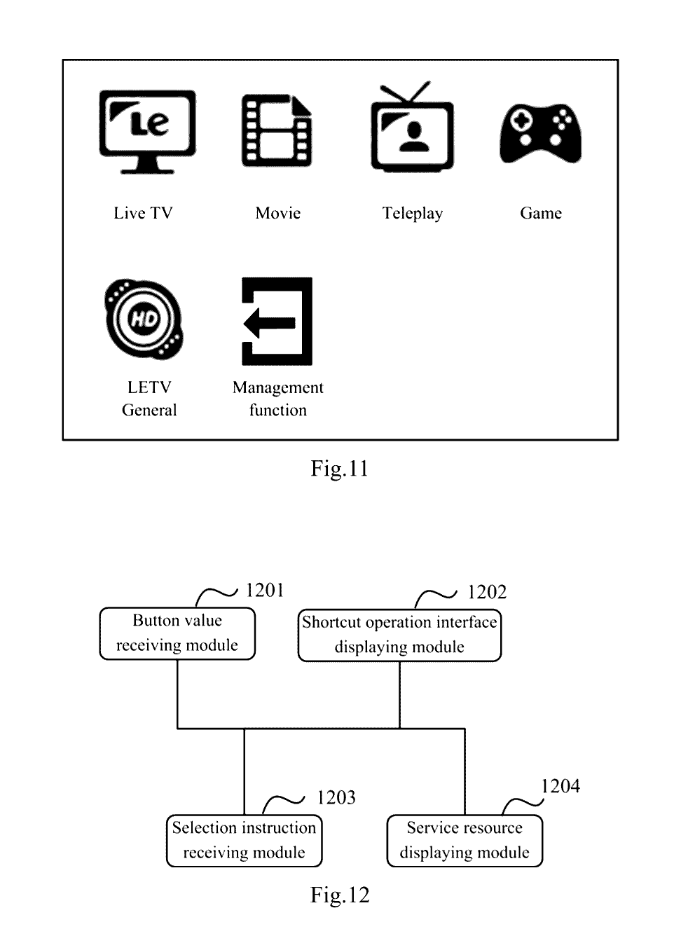

Based upon the same inventive idea, an embodiment of the disclosure further provides a controlled device as illustrated in FIG. 12 which is a schematic structural diagram of the device including:

A button value receiving module 1201 is configured to receive a button value transmitted by a remote controller;

A shortcut operation interface displaying module 1202 is, if the received button value is a pre-stored button value of a customized key, configured to display a shortcut operation interface including a pre-configured set of shortcut entrance identifiers of at least one service resource;

A selection instruction receiving module 1203 is configured to receive a selection instruction transmitted by the remote controller for a shortcut entrance identifier in the set of shortcut entrance identifiers; and

A service resource displaying module 1204 is configured to open a service resource corresponding to the selected shortcut entrance identifier.

Here in an embodiment, the set of shortcut entrance identifiers includes a shortcut entrance identifier of a management function to manage the shortcut operation interface; and

If the selected shortcut entrance identifier is the shortcut entrance identifier of the management function, then the opened service resource is an operation interface of the management function.

Here in an embodiment, the device further includes:

A control instruction receiving module is configured to receive a control instruction for the set of shortcut entrance identifiers after the service resource displaying module opens the operation interface of the management function, where the control instruction includes any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter the position where a shortcut entrance identifier in the set of shortcut entrance identifiers is displayed in the shortcut operation interface; and

A performing module is configured to perform a corresponding operation in response to the control instruction.

Here in an embodiment, the service resource displaying module is configured to retrieve display information of the operation interface of the management function from a preset shortcut function database; and

To display the operation interface of the management function according to the display information.

Here in an embodiment, the operation interface of the management function includes an entrance to an addition interface to add a shortcut entrance identifier to the set of shortcut entrance identifiers; and if the control instruction is the addition instruction, then the control instruction receiving module is configured to receive a selection instruction transmitted by the remote controller for the entrance to the addition interface, and to retrieve from the shortcut function database and display at least one category identifier of the service resource in response to the selection instruction;

To receive a selection instruction transmitted by the remote controller for the category identifier, and to retrieve from the shortcut function database and display a shortcut entrance identifier of at least one service resource corresponding to the selected category identifier in response to the selection instruction; and

To receive a selection instruction transmitted by the remote controller for the shortcut entrance identifier, and to determine the selection instruction as the addition instruction.

With the controlled device according to the embodiments of the disclosure, if the received button value is the button value of the customized button, then the shortcut operation interface will be displayed which includes a pre-configured set of shortcut entrance identifiers of at least one service resource, so that the user can access the shortcut operation interface using the customized button to thereby access the service resource to be accessed, via the shortcut operation interface. For example, the user can set as needed a shortcut entrance identifier of a service resource of interest in the shortcut operation interface, so that the user can enter the shortcut operation interface using the customized button, and search for and access the resource of interest rapidly in the shortcut operation interface. The operation steps of selecting the resource to be accessed can be saved, the operations by the user can be simplified, and the experience of the user can be improved, as compared with the prior art in which the user has to search for and access the resource among a large number of service resources of no interest to the user in a number of levels of TV menus through the remote controller.

### Fifth Embodiment

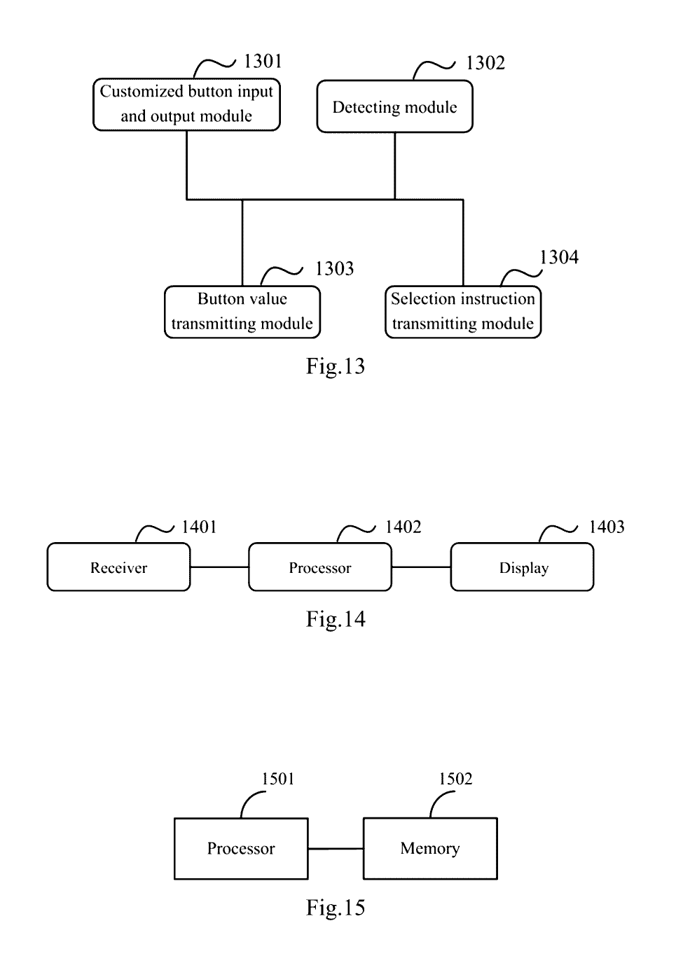

Based upon the same inventive idea, an embodiment of the disclosure further provides a remote controller as illustrated in FIG. 13 which is a schematic structural diagram of the remote controller including:

A customized button input and output module 1301;

A detecting module 1302 is configured to detect an operation performed on a customized button on the remote controller;

A button value transmitting module 1303 is configured, if the detected operation is a preset operation, to transmit a button value of the customized button to a controlled device so that the controlled device displays a shortcut operation interface including a preconfigured set of shortcut entrance identifiers of at least one service resource; and

A selection instruction transmitting module 1304 is to transmit a selection instruction for a shortcut entrance identifier in the set of shortcut entrance identifiers to the controlled device so that the controlled device opens the service resource corresponding to the selected shortcut entrance identifier.

Here in an embodiment, the set of shortcut entrance identifiers includes a shortcut entrance identifier of a management function to manage the shortcut operation interface.

Here in an embodiment, the remote controller further includes:

A control instruction transmitting module is configured to transmit a control instruction for the set of shortcut entrance identifiers to the controlled device so that the controlled device performs a corresponding operation in response to the control instruction, where the control instruction includes any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter the position where a shortcut entrance identifier in the set of shortcut entrance identifiers is displayed in the shortcut operation interface.

With the remote controllers according to the embodiments of the disclosure, the user can call out the shortcut operation interface using the customized button, and locate the shortcut entrance to the resource to be accessed, via the shortcut operation interface, so that the operation steps of selecting the resource to be accessed can be saved, the operations by the user can be simplified, and the experience of the user can be improved, as compared with the prior art in which the user has to search for and access the resource among a large number of service resources of no interest to the user in a number of levels of TV menus through the remote controller.

### Sixth Embodiment

Based upon the same inventive idea, an embodiment of the disclosure further provides a controlled device as illustrated in FIG. 14 which is a schematic structural diagram of the device including:

A receiver 1401 is configured to receive a button value transmitted by a remote controller;

A processor 1402 is, if it is determined that the received button value is a pre-stored button value of a customized key, configured to transmit a shortcut operation interface to a display for displaying, where the shortcut operation interface includes a pre-configured set of shortcut entrance identifiers of at least one service resource, and to open a service resource corresponding to the selected shortcut entrance identifier; and

The display 1403 is configured to display the shortcut operation interface.

The receiver 1401 is further configured to receive a selection instruction transmitted by the remote controller for a shortcut entrance identifier in the set of shortcut entrance identifiers; and

The processor 1402 is further configured to open a service resource corresponding to the selected shortcut entrance identifier.

Here in an embodiment, the set of shortcut entrance identifiers includes a shortcut entrance identifier of a management function to manage the shortcut operation interface; and

If the selected shortcut entrance identifier is the shortcut entrance identifier of the management function, then the opened service resource is an operation interface of the management function.

Here in an embodiment, the receiver 1401 is further configured to receive a control instruction for the set of shortcut entrance identifiers after the processor 1402 opens the operation interface of the management function, where the control instruction includes any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter the position where a shortcut entrance identifier in the set of shortcut entrance identifiers is displayed in the shortcut operation interface; and

The processor 1402 is further configured to perform a corresponding operation in response to the control instruction.

Here in an embodiment, the processor 1402 is configured to retrieve display information of the operation interface of the management function from a preset shortcut function database; and

The display 1403 is further configured to display the operation interface of the management function according to the display information.

Here in an embodiment, the operation interface of the management function includes an entrance to an addition interface to add a shortcut entrance identifier to the set of shortcut entrance identifiers; and if the control instruction is the addition instruction, then the receiver 1401 is configured to receive a selection instruction transmitted by the remote controller for the entrance to the addition interface;

The processor 1402 is further configured to retrieve from the shortcut function database at least one category identifier of the service resource in response to the selection instruction;

The display 1403 is further configured to display the at least one category identifier retrieved by the processor 1402;

The receiver 1401 is further configured to receive a selection instruction transmitted by the remote controller for the category identifier;

The processor 1402 is further configured to retrieve from the shortcut function database a shortcut entrance identifier of at least one service resource corresponding to the selected category identifier in response to the selection instruction;

The display 1403 is further configured to display the shortcut entrance identifier of the at least one service resource corresponding to the selected category identifier retrieved by the processor 1402;

The receiver 1401 is further configured to receive a selection instruction transmitted by the remote controller for the shortcut entrance identifier; and

The processor 1402 is further configured to determine the selection instruction as the addition instruction.

Particular implementations of the operations performed by the respective modules in the devices according to the embodiments above have been described in details in the embodiments of the methods, so a detailed description thereof will not be repeated here.

### Seventh Embodiment

Based upon the same inventive idea, an embodiment of the disclosure further provides a controller as illustrated in FIG. 15 which is a schematic structural diagram of the device including:

At least one processor 1501 and a memory 1502, where there is one processor as an example in FIG. 15.

The memory 1502 is communicably connected with the at least one processor for storing instructions executable by the at least one processor, wherein execution of the instructions by the at least one processor causes the at least one processor to:

detect an operation performed on a customized button on the remote controller;

if the detected operation is a preset operation, then transmit a button value of the customized button to a controlled device so that the controlled device displays a shortcut operation interface comprising a preconfigured set of shortcut entrance identifiers of at least one service resource; and

transmit a selection instruction for a shortcut entrance identifier in the set of shortcut entrance identifiers to the controlled device so that the controlled device opens a service resource corresponding to the selected shortcut entrance identifier.

In one embodiment, the set of shortcut entrance identifiers comprises a shortcut entrance identifier of a management function to manage the shortcut operation interface.

in one embodiment, the execution of the instructions by the at least one processor causes the at least one processor to:

transmit a control instruction for the set of shortcut entrance identifiers to the controlled device so that the controlled device performs a corresponding operation in response to the control instruction, wherein the control instruction comprises any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter a position where a shortcut entrance identifier in the set of shortcut entrance identifiers is displayed in the shortcut operation interface.

Those ordinarily skilled in the art can appreciate that all or a part of the operations in the methods according to the embodiments described above can be performed by program instructing relevant hardware, where the programs can be stored in a computer readable storage medium, and the programs can perform one or a combination of the operations in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A remote control method applicable to a controlled device, the method comprising:
receiving a button value transmitted by a remote controller;
if the received button value is a pre-stored button value of a customized key, then displaying a shortcut operation interface comprising a pre-configured set of shortcut entrance identifiers of at least one service resource;
receiving a selection instruction transmitted by the remote controller for a shortcut entrance identifier in the set of shortcut entrance identifiers; and
opening a service resource corresponding to the selected shortcut entrance identifier.

2. The method according to claim 1, wherein the set of shortcut entrance identifiers comprises a shortcut entrance identifier of a management function to manage the shortcut operation interface; and
if the selected shortcut entrance identifier is the shortcut entrance identifier of the management function, then the opened service resource is an operation interface of the management function.

3. The method according to claim 2, wherein after the operation interface of the management function is opened, the method further comprises:
receiving a control instruction for the set of shortcut entrance identifiers, wherein the control instruction comprises any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter a position where a shortcut entrance identifier in the set of shortcut entrance identifiers is displayed in the shortcut operation interface; and
performing a corresponding operation in response to the control instruction.

4. The method according to claim 3, wherein the opening the operation interface of the management function comprises:
retrieving display information of the operation interface of the management function from a preset shortcut function database, and
displaying the operation interface of the management function according to the display information.

5. The method according to claim 4, wherein the operation interface of the management function comprises an entrance to an addition interface to add a shortcut entrance identifier to the set of shortcut entrance identifiers; and
if the control instruction is the addition instruction, then the receiving the control instruction for the set of shortcut entrance identifiers comprises:
receiving a selection instruction transmitted by the remote controller for the entrance to the addition interface, and retrieving from the shortcut function database and displaying at least one category identifier of the service resource in response to the selection instruction;
receiving a selection instruction transmitted by the remote controller for the category identifier, and retrieving from the shortcut function database and displaying a shortcut entrance identifier of at least one service resource corresponding to the selected category identifier in response to the selection instruction; and
receiving a selection instruction transmitted by the remote controller for the shortcut entrance identifier, and determining the selection instruction as the addition instruction.

6. A remote control method applicable to a remote controller, the method comprising:
detecting an operation performed on a customized button on the remote controller;
if the detected operation is a preset operation, then transmitting a button value of the customized button to a controlled device so that the controlled device displays a shortcut operation interface comprising a preconfigured set of shortcut entrance identifiers of at least one service resource; and
transmitting a selection instruction for a shortcut entrance identifier in the set of shortcut entrance identifiers to the controlled device so that the controlled device opens a service resource corresponding to the selected shortcut entrance identifier.

7. The method according to claim 6, wherein the set of shortcut entrance identifiers comprises a shortcut entrance identifier of a management function to manage the shortcut operation interface.

8. The method according to claim 7, wherein if the selected shortcut entrance identifier is the shortcut entrance identifier of the management function, then after the selection instruction for the shortcut entrance identifier in the set of shortcut entrance identifiers is transmitted to the controlled device, the method further comprises:
transmitting a control instruction for the set of shortcut entrance identifiers to the controlled device so that the controlled device performs a corresponding operation in response to the control instruction, wherein the control instruction comprises any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter a position where a shortcut entrance identifier in the set of shortcut entrance identifiers is displayed in the shortcut operation interface.

9. A controlled device, comprising:
at least one processor; and
a memory communicably connected with the at least one processor for storing instructions executable by the at least one processor, wherein execution of the instructions by the at least one processor causes the at least one processor to:
receive a button value transmitted by a remote controller;
if the received button value is a pre-stored button value of a customized key, then display a shortcut operation interface comprising a pre-configured set of shortcut entrance identifiers of at least one service resource;
receive a selection instruction transmitted by the remote controller for a shortcut entrance identifier in the set of shortcut entrance identifiers; and
open a service resource corresponding to the selected shortcut entrance identifier.

10. The device according to claim 9, wherein the set of shortcut entrance identifiers comprises a shortcut entrance identifier of a management function to manage the shortcut operation interface; and
if the selected shortcut entrance identifier is the shortcut entrance identifier of the management function, then the opened service resource is an operation interface of the management function.

11. The device according to claim 10, wherein the execution of the instructions by the at least one processor further causes the at least one processor to:
receive a control instruction for the set of shortcut entrance identifiers after the operation interface of the management function is opened, wherein the control instruction comprises any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter a position where a shortcut entrance identifier in the set of shortcut entrance identifiers is displayed in the shortcut operation interface; and
perform a corresponding operation in response to the control instruction.

12. The device according to claim 11, wherein the execution of the instructions by the at least one processor further causes the at least one processor to retrieve display information of the operation interface of the management function from a preset shortcut function database; and
to display the operation interface of the management function according to the display information.

13. The device according to claim 12, wherein the operation interface of the management function comprises an entrance to an addition interface to add a shortcut entrance identifier to the set of shortcut entrance identifiers; and if the control instruction is the addition instruction, then the execution of the instructions by the at least one processor causes the at least one processor to receive a selection instruction transmitted by the remote controller for the entrance to the addition interface, and to retrieve from the shortcut function database and to display at least one category identifier of the service resource in response to the selection instruction;
to receive a selection instruction transmitted by the remote controller for the category identifier, and to retrieve from the shortcut function database and to display a shortcut entrance identifier of at least one service resource corresponding to the selected category identifier in response to the selection instruction; and
to receive a selection instruction transmitted by the remote controller for the shortcut entrance identifier, and to determine the selection instruction as the addition instruction.

14. A remote controller, comprising:
at least one processor; and
a memory communicably connected with the at least one processor for storing instructions executable by the at least one processor, wherein execution of the instructions by the at least one processor causes the at least one processor to:
detect an operation performed on a customized button on the remote controller;
if the detected operation is a preset operation, then transmit a button value of the customized button to a controlled device so that the controlled device displays a shortcut operation interface comprising a preconfigured set of shortcut entrance identifiers of at least one service resource; and
transmit a selection instruction for a shortcut entrance identifier in the set of shortcut entrance identifiers to the controlled device so that the controlled device opens a service resource corresponding to the selected shortcut entrance identifier.

15. The remote controller according to claim 14, wherein the set of shortcut entrance identifiers comprises a shortcut entrance identifier of a management function to manage the shortcut operation interface.

16. The remote controller according to claim 15, wherein the execution of the instructions by the at least one processor causes the at least one processor to:
transmit a control instruction for the set of shortcut entrance identifiers to the controlled device so that the controlled device performs a corresponding operation in response to the control instruction, wherein the control instruction comprises any one of an addition instruction to add a shortcut entrance identifier to the set of shortcut entrance identifiers, a deletion instruction to delete a shortcut entrance identifier in the set of shortcut entrance identifiers, a rename instruction to rename a shortcut entrance in the set of shortcut entrance identifiers, and a movement instruction to alter a position where a shortcut entrance identifier in the set of shortcut entrance identifiers is displayed in the shortcut operation interface.
